(19) United States
(12) Patent Application Publication
(10) Pub. No.: US 2025/0060276 A1
(43) Pub. Date: Feb. 20, 2025

(54) SYSTEM AND METHOD OF OPTICAL MEASUREMENT OF NUMERICAL APERTURE OF OBJECTIVE LENS

(71) Applicant: SAMSUNG ELECTRONICS CO., LTD., Suwon-si (KR)

(72) Inventors: Yeeun Park, Suwon-si (KR); Seungwoo Lee, Suwon-si (KR); Taejoong Kim, Suwon-si (KR); Jinwoo Ahn, Suwon-si (KR); Seoyeon Jeong, Suwon-si (KR); Taeyong Jo, Suwon-si (KR)

(21) Appl. No.: 18/651,417

(22) Filed: Apr. 30, 2024

(30) Foreign Application Priority Data
Aug. 14, 2023 (KR) 10-2023-0106036

(51) Int. Cl. G01M 11/02

(52) U.S. Cl. CPC G01M 11/0257; G01M 11/0207

(57) ABSTRACT

An optical measurement system includes a hemispherical mirror including a planar portion and a spherical portion having a hemispherical recessed shape in the planar portion. In the spherical portion are latitude markers formed with a different reflectance from the rest of the spherical portion. The system includes an optical unit with an objective lens and at least one beam splitter. The optical unit transmits light reflected from the hemispherical mirror through the objective lens to a first sensor. A controller measures a numerical aperture of the objective lens by aligning the hemispherical mirror to be at the focus of the objective lens, detecting a back focal image of the objective lens in which the latitude markers appear as darker circular lines, and performing calculations on the image.

### CROSS-REFERENCE TO RELATED APPLICATION(S)

This application claims benefit of priority to Korean Patent Application No. 10-2023-0106036 filed on Aug. 14, 2023, in the Korean Intellectual Property Office, the disclosure of which is incorporated herein by reference in its entirety.

### TECHNICAL FIELD

The present disclosure relates to an optical measurement system and a measurement method of a numerical aperture of an objective lens.

### BACKGROUND

In an optical measurement system, a numerical aperture of an objective lens plays an important role in determining the performance and accuracy of the system. For example, the objective lens may determine the resolution of the optical measurement system. Furthermore, in the case of an Angle-Resolved Ellipsometry method which utilizes an objective lens to change polarization characteristics of light at a continuous incidence angle, measurement data may be accurately interpreted only when the numerical aperture of the objective lens is accurately recognized. Accordingly, accurate measurement of the numerical aperture of the objective lens may be decisive in the optical measurement system.

The numerical aperture of the objective lens may vary, depending on a production deviation of the objective lens, and when the objective lens is mounted on the optical measurement system, the numerical aperture of the objective lens may vary, depending on optical conditions such as a degree of collimation of light incident on the objective lens, or environments such as the temperature and pressure of the optical measurement system.

### SUMMARY

The present disclosure provides an optical measurement system for measuring a numerical aperture of an objective lens in all directions, and a measurement method of the numerical aperture of the objective lens, in a mounting environment of the objective lens.

In an example, an optical measurement system includes: a hemispherical mirror including a planar portion, a spherical portion having a hemispherical recessed shape in the planar portion, and a plurality of latitude markers formed in the spherical portion to have different reflectance from the spherical portion; an optical unit including an objective lens for allowing light incident from a light source to be incident on the hemispherical mirror, and at least one beam splitter for transmitting light reflected from the hemispherical mirror and incident on the objective lens, to a first sensor; and a controller for measuring a numerical aperture of the objective lens using a back focal image of the objective lens output by the first sensor in a state in which the hemispherical mirror is aligned so that a focus of the objective lens and a center of the spherical portion of the hemispherical mirror are matched with each other.

In another example, an optical measurement system includes: a hemispherical mirror including a planar portion, a spherical portion having a hemispherical recessed shape in the planar portion, and a plurality of latitude markers formed in the spherical portion to have a reflectance different from that of the spherical portion; a stage in which a substrate chuck for loading a semiconductor substrate and an alignment system equipped with the hemispherical mirror are disposed; an optical unit including an objective lens for allowing light incident from a light source to be incident on a target, and a beam splitter for transmitting light reflected from the target and incident on the objective lens to a first sensor; and a controller for setting the hemispherical mirror as the target of the objective lens by adjusting a position of the stage, and measuring a numerical aperture of the objective lens using a back focal image of the objective lens output by the first sensor.

In another example, an optical measurement system includes: a hemispherical mirror including a plurality of latitude markers in a spherical portion to have different reflectance from the spherical portion; a light source; an objective lens; and a controller configured to match an center of the spherical portion with a focus of the objective lens; allow light output from the light source to be incident on the spherical portion through the objective lens; detect circular patterns formed by the plurality of latitude markers in a back focal image of the objective lens; calculate a partial numerical aperture of the objective lens according to a radius of each of the circular patterns based on the radius of each of the circular patterns and a latitude indicated by the plurality of latitude markers; and determine the numerical aperture of the objective lens according to a radius of a pupil image in the back focal image, based on the partial numerical aperture according to the radius of each of the circular patterns.

In an example, an optical measurement system and a measurement method of a numerical aperture of an objective lens may measure a numerical aperture of the objective lens using a light source inside the system in a state in which the objective lens is mounted on the system. Accordingly, the numerical aperture of the objective lens may be measured in-situ.

In an example, an optical measurement system and a measurement method of a numerical aperture of an objective lens may calculate the numerical aperture of the objective lens using an image in all directions, obtained by lighting a hemispherical mirror having a plurality of latitude lines. Accordingly, it may be possible to measure the numerical aperture of the objective lens in all directions, and accurately calculate the numerical aperture using a plurality of reference values.

The aspects to be solved by the present disclosure are not limited to the above-mentioned aspects, and other aspects not mentioned herein will be clearly understood by those skilled in the art from the following description.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating an example optical measurement system;

FIGS. 2A to 2C are views illustrating an example hemispherical mirror;

FIGS. 3A and 3B are views illustrating an example measurement method of a numerical aperture of an objective lens;

FIG. 4 is a flowchart illustrating an example measurement method of a numerical aperture of an objective lens;

FIG. 5 is a view illustrating an example method of processing an image on a back focal plane;

FIG. 6 is a view illustrating an example alignment system of a hemispherical mirror in an optical measurement system;

FIGS. 7A to 7C are view illustrating an example method of aligning a vertical position of a hemispherical mirror;

FIGS. 8A and 8B are views illustrating an example method of aligning horizontal positions of a hemispherical mirror;

FIG. 9 is a view illustrating an example method of aligning horizontal positions of a hemispherical mirror;

FIG. 10 is a view illustrating an example structure of an alignment system;

FIGS. 11A to 11E are graphs illustrating a numerical aperture for each wavelength of an objective lens measured;

FIG. 12 is a graph illustrating accuracy of a numerical aperture of an objective lens measured;

FIGS. 13A and 13B are views illustrating example repeatability of a measurement method of a numerical aperture of an objective lens;

FIG. 14 is a graph illustrating repeated precision of an example measurement method of a numerical aperture of an objective lens according to a radius of a hemispherical mirror;

FIG. 15 is a graph illustrating precision of an example measurement method of a numerical aperture of an objective lens according to the number of latitude lines formed in a hemispherical mirror; and

FIGS. 16A to 16C are views illustrating precision of an example measurement method of a numerical aperture of an objective lens according to a processing error of a hemispherical mirror; and

FIGS. 17 to 20 are views illustrating example structures of a hemispherical mirror.

### DETAILED DESCRIPTION

Hereinafter, example implementations of the present disclosure will be described with reference to the accompanying drawings.

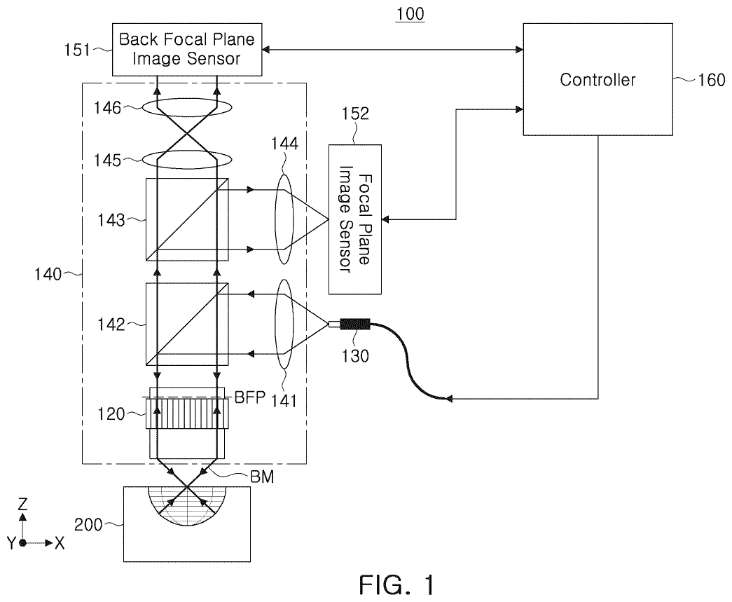

FIG. 1 is a view illustrating an example optical measurement system.

Referring to FIG. 1, an optical measurement system 100 may include an optical unit 140, a light source 130, a first image sensor 151, a second image sensor 152, a controller 160, and a hemispherical mirror 200. The optical unit 140 may include an objective lens 120, an illumination lens 141, a first beam splitter 142, a second beam splitter 143, a condensing lens 144, a first relay lens 145, and a second relay lens 146.

The light source 130 may output light incident on a target. The light may be light including a wavelength ranging from an ultraviolet wavelength band to an infrared wavelength band, or may be monochromatic light having a specific wavelength.

The light output from the light source 130 may be irradiated to the illumination lens 141. The illumination lens 141 may be a convex lens, and may adjust an angular distribution of the light output from the light source 130 to allow light to be incident on the first beam splitter 142. For example, the illumination lens 141 may convert the light irradiated from the light source 130 into parallel light.

The first beam splitter 142 may reflect some of the light received through the illumination lens 141 and transmit others thereof. Light reflected from the first beam splitter 142 may be incident on the objective lens 120, and light passing through the objective lens 120 may be incident on a target.

When the light passing through the objective lens 120 is reflected from the target, the objective lens 120 may receive the reflected light. The light received from the objective lens 120 may be transmitted to the first beam splitter 142. Meanwhile, the objective lens 120 includes a front surface facing the sample and a rear surface disposed on an opposite side of the sample, and a back focal plane (BFP) may be defined at a predetermined distance from the rear surface of the objective lens 120.

The back focal plane BFP may be an X-Y plane defined in a first direction (X-direction) and a second direction (Y-direction) orthogonal to the first direction. The light passing through the objective lens 120 may be condensed in the form of a point on the target, and may be reflected back from a target region and then pass through the objective lens 120 to proceed to the back focal plane BFP.

The second beam splitter 143 may transmit some of the light transmitted from the first beam splitter 142 and reflect others thereof. The first relay lens 145 and the second relay lens 146 may sequentially pass light transmitted from the second beam splitter 143. The light passing through the second relay lens 146 may be incident on the first image sensor 151. The first image sensor 151 may obtain a back focal image that is an image of the back focal plane BFP using light incident from the second relay lens 146.

The condensing lens 144 may condense the light reflected from the second beam splitter 143 at one focal point. The second image sensor 152 may obtain a focus image of the objective lens 120 using the light condensed from the condensing lens 144.

The controller 160 may control the optical measurement system 100. For example, the controller 160 may control the light source 130, the first image sensor 151, and the second image sensor 152. Furthermore, the controller 160 may obtain a measurement value using an image obtained from the first image sensor 151, and perform subsequent control using an image obtained from the second image sensor 152.

Meanwhile, the numerical aperture (NA) of the objective lens 120 may determine the resolution of the optical measurement system 100, and determine the accuracy of a measurement value of the optical measurement system 100 by performing an Angle-Resolved Ellipsometry method.

When there is a variation in the numerical aperture of objective lenses mounted on optical measurement facilities, the resolution may vary for each optical measurement facility, and tool-to-tool matching (TTTM) of optical measurement facilities may be difficult to achieve. Furthermore, the accuracy of the measurement value may be reduced in optical measurement facilities that perform angular decomposition ellipsometry measurement methods.

A numerical aperture value provided by a manufacturer of the objective lens 120 is a design value, and this may be frequently different from an actual numerical aperture due to production variations of the objective lens 120. Furthermore, the numerical aperture may vary, depending on the optical conditions in which the objective lens 120 is used, or the mounting environment in the optical measurement system 100. Accordingly, accurate measurement of the numerical aperture of the objective lens 120 mounted in the optical measurement system 100 may be required to accurately determine the as-installed numerical aperture of the objective lens.

To measure the numerical aperture of the objective lens in-situ, the method of this disclosure is proposed. The objective lens has a diffraction grating disposed on a front surface of the objective lens. The optical measurement system allows the light, output from an internal light source, to be incident on the diffraction grating through the objective lens. In addition, zero-order reflected light and +n-order diffracted light (where n is a natural number) output from the diffraction grating is incident on the back focal plane and forms a pattern. Analyzing this pattern permits calculating the numerical aperture of the objective lens.

However, according to the method using the diffraction grating, since the intensity of light of diffracted light of +2 order or higher is insufficiently bright, the numerical aperture of the objective lens may be calculated using only a pattern formed by +1 order diffracted light. Accordingly, the number of reference values for calculating the numerical aperture of the objective lens may be insufficient. When the number of reference values is insufficient, there is a high possibility that an error will occur in the calculated numerical aperture. Furthermore, in order to measure the numerical aperture of the objective lens in all directions, it may be necessary to obtain a plurality of back focal images according to angles of the diffraction grating while rotating the diffraction grating, which may cause the measurement to take a long time.

In an example implementation, in order to measure the numerical aperture of the objective lens 120, a hemispherical mirror 200 may be disposed on a front surface of the objective lens 120. The hemispherical mirror 200 may include a plurality of latitude markers formed in the spherical portion to have a reflectance different from that of the spherical portion. Latitude may refer to an angle at which a point in the spherical portion forms from the center of the spherical portion to the Z-axis, and examples of the plurality of latitude markers may be a plurality of latitude lines formed at regular latitude intervals in the spherical portion.

In an example implementation, the optical measurement system 100 may measure the numerical aperture in all directions using a plurality of reference values, in the mounting environment of the objective lens 120 using the back focal image of the objective lens 120 formed by light reflected from the hemispherical mirror 200 and incident on the objective lens 120, in a state in which the hemispherical mirror 200 is aligned so that the center of the spherical portion of the hemispherical mirror 200 is matched with a focus of the objective lens 120.

Hereinafter, an optical measurement system and a measurement method of a numerical aperture of an objective lens will be described in detail.

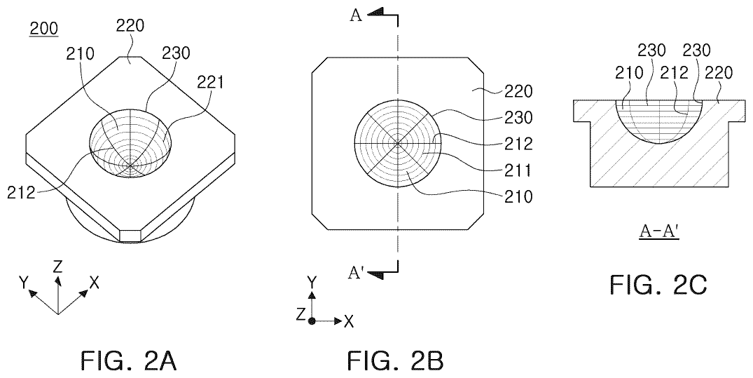

FIGS. 2A to 2C are views illustrating an example hemispherical mirror. FIG. 2A is a perspective view of a hemispherical mirror, FIG. 2B is a plan view of indicating the hemispherical mirror in an X-Y plane, and FIG. 2C is a cross-sectional view of line A-A′ of FIG. 2B.

Referring to FIGS. 2A to 2C, a hemispherical mirror 200 may include a spherical portion 210, a planar portion 220, and a boundary line 230. The spherical portion 210 may be a surface having a hemispherical concave shape in the planar portion 220, and the boundary line 230 may be a boundary between the spherical portion 210 and the planar portion 220.

The spherical portion 210 and the planar portion 220 may be formed of a mirror surface. According to an example embodiment, the spherical portion 210 and the planar portion 220 may be formed of a material having the same reflectance.

A plurality of latitude lines 211 may be formed on the spherical portion 210. Each of the plurality of latitude lines 211 may be a line for connecting points having the same latitude on the spherical portion 210. For example, the plurality of latitude lines 211 may be formed at regular latitude intervals.

The plurality of latitude lines 211 may be formed to have a reflectance different from that of the spherical portion 210. For example, the plurality of latitude lines 211 may be formed by engraving the spherical portion 210, and the plurality of latitude lines 211 may scatter incident light. According to an example embodiment, the plurality of intaglio latitude lines 211 may be filled with a material having a lower reflectance than that of the spherical portion 210. The present disclosure is not limited thereto, and the plurality of latitude lines 211 may be embossed from the spherical portion 210, and the plurality of latitude lines 211 may be formed of a material having lower or higher reflectance than that of the spherical portion.

According to an example embodiment, a plurality of longitude lines 212 may be further formed on the spherical portion 210. Each of the plurality of longitude lines 212 may be a line for connecting points having the same longitude, that is, an angle with the X-axis or the Y-axis based on the center of the spherical portion 210.

In an example implementation, light incident on the center of the spherical portion of the hemispherical mirror 200 through the objective lens 120 may be incident on the spherical portion 210 and the plurality of latitude lines 211 according to the incident angle. Since the spherical portion 210 and the plurality of latitude lines 211 have different reflectance, concentric patterns in which the plurality of latitude lines 211 are transferred may be displayed in the back focal image. The numerical aperture of the objective lens may be calculated based on a radius of the concentric patterns displayed in the back focal image and the latitude indicated by the plurality of latitude lines 211.

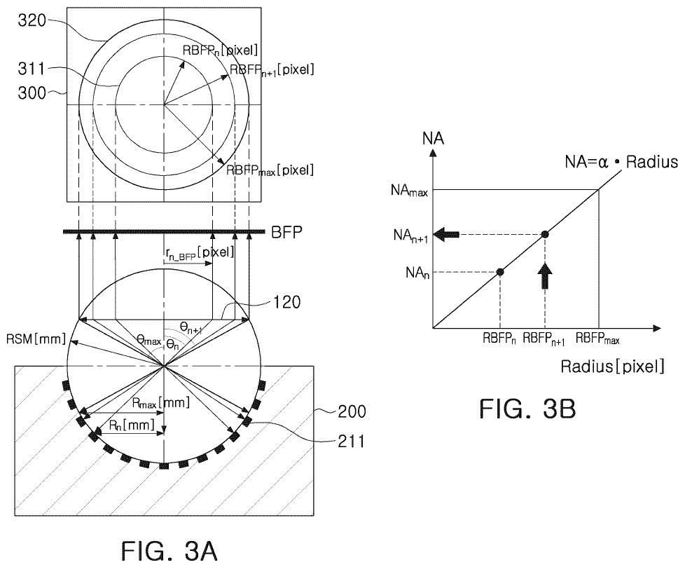

FIGS. 3A and 3B are views illustrating an example measurement method of a numerical aperture of an objective lens.

FIG. 3A illustrates an objective lens 120, a hemispherical mirror 200, a back focal plane BFP, and a back focal image 300.

Referring to FIG. 3A, the hemispherical mirror 200 may be aligned so that the center spherical portion of the hemispherical mirror 200 is matched with a focus of the objective lens 120. In a state in which the hemispherical mirror 200 is aligned, light entering the hemispherical mirror 200 from the objective lens 120 may pass the focus of the objective lens 120 and may be incident on a spherical portion 210 of the hemispherical mirror 200 and a plurality of latitude lines 211.

A pupil image having a different radius depending on the numerical aperture of the objective lens 120 may be displayed on the back focal image 300. In FIG. 3A, a boundary line 320 of the pupil image is illustrated. In the pupil image, a plurality of concentric patterns 311 formed by transferring the plurality of latitude lines 211 having different reflectance from the spherical portion 210 to the back focal image 300 may be displayed.

On the other hand, when the center of the spherical portion of the hemispherical mirror 200 and the focus of the objective lens 120 are matched with each other, light incident on the hemispherical mirror 200 after passing through the focus of the objective lens 120 may be vertically incident on the spherical portion 210, and retro-reflection reflected in the incident direction may occur. Accordingly, the latitude indicated by each of the plurality of latitude lines 211 corresponding to the plurality of concentric patterns 311 may be identical to an incident angle of light incident on a focus in the objective lens 120.

The numerical aperture of the objective lens 120 may be calculated as Equation 1 below.

$$NA = n sin ( {θ}_{max} ) = n \frac{{R}_{max}}{f} \qquad < Equation 1 >$$

In Equation 1, NA is the numerical aperture of the objective lens, n is a refractive index, θₘₐₓ is a maximum incidence angle of the objective lens, Rₘₐₓ is a radius of the pupil image, and f is a focal length. When the objective lens is a dry lens (i.e., operates in air), the refractive index of the medium may be n=1. Referring to Equation 1, the numerical aperture of the objective lens may be proportional to the radius of the pupil image.

In an example implementation, based on a partial numerical aperture of the objective lens 120 in each of the plurality of concentric patterns 311, the numerical aperture of the objective lens 120 may be calculated according to the radius of the pupil image.

A partial numerical aperture NAₙ in the nth concentric circle having a radius RBFPₙ in the back focal image 300 may be calculated as Equation 2 below.

$${NA}_{n} = sin {θ}_{n} = \frac{{R}_{n}}{R S M} \qquad < Equation 2 >$$

In Equation 2, NAₙ is a partial numerical aperture in the nth concentric circle, On may be a latitude in the nth concentric circle, Rₙ may be a radius of the nth latitude line forming an image of the nth concentric circle, and RSM may be a radius of the spherical portion.

According to Equation 2, a controller 160 may determine a sine function value for each of latitudes based on radii of a plurality of latitude lines 211 and a radius of the spherical portion 210. Furthermore, the controller 160 may determine the partial numerical aperture of the objective lens 120 according to a radius of each of the plurality of concentric patterns 311 based on the sine function value and the radius of each of the plurality of concentric patterns 311. Based on a relationship between the radius of each of the plurality of concentric patterns 311 and the partial numerical aperture of the objective lens 120, a function of the numerical aperture of the objective lens 120 according to the radius of the pupil image may be obtained.

Referring to FIG. 3B, the relationship between the radius of the pupil image and the numerical aperture of the objective lens 120 is illustrated. The numerical aperture NAₘₐₓ of the objective lens in a radius Rₘₐₓ may be determined based on the partial numerical aperture in concentric circles formed inside the pupil image.

In an example implementation, the optical measurement system 100 may determine the partial numerical aperture NAₙ and NAₙ+1 for each of the plurality of concentric patterns 311 formed inside the pupil image. The relationship between the radius of the plurality of concentric patterns 311 and the partial numerical aperture may be approximated as a linear function which permits the optical measurement system 100 to calculate the numerical aperture NAₘₐₓ of the objective lens 120 at the radius Rₘₐₓ of the pupil image.

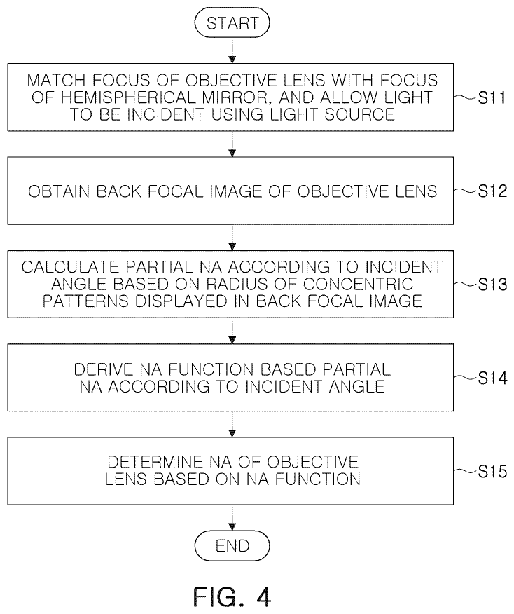

FIG. 4 is a flowchart illustrating an example measurement method of a numerical aperture of an objective lens.

In operation S11, an optical measurement system 100 may match a focus of an objective lens 120 with a focus of a hemispherical mirror 200, and allow light to be incident on the objective lens 120 using a light source 130.

In operation S12, the optical measurement system 100 may obtain a back focal image 300 of the objective lens 120. As described with reference to FIG. 3A, the back focal image 300 may be formed by light reflected from the hemispherical mirror 200 based on the light incident on the objective lens 120 and may have a plurality of concentric patterns 311 formed by a plurality of latitude lines 211.

In operation S13, the optical measurement system 100 may calculate a partial numerical aperture in a position in which the plurality of concentric patterns 311 are shown. The partial numerical aperture in the position in which a certain concentric pattern is shown may be calculated based on a radius of a latitude line corresponding to the concentric pattern and a radius of a spherical portion 210 of the hemispherical mirror 200.

In operation S14, the optical measurement system 100 may derive a linear function indicative of the numerical aperture of the objective lens 120 according to a radius of a pupil image based on the partial numerical aperture in the plurality of concentric patterns 311.

In operation S15, the optical measurement system 100 may determine the numerical aperture of the objective lens 120 based on the radius of the pupil image displayed in the back focal image 300 and the linear function.

Meanwhile, in order to determine the radius of the plurality of concentric patterns 311 and the radius of the pupil image based on the back focal image 300, image processing may be performed on the back focal image 300 captured by a first image sensor 151.

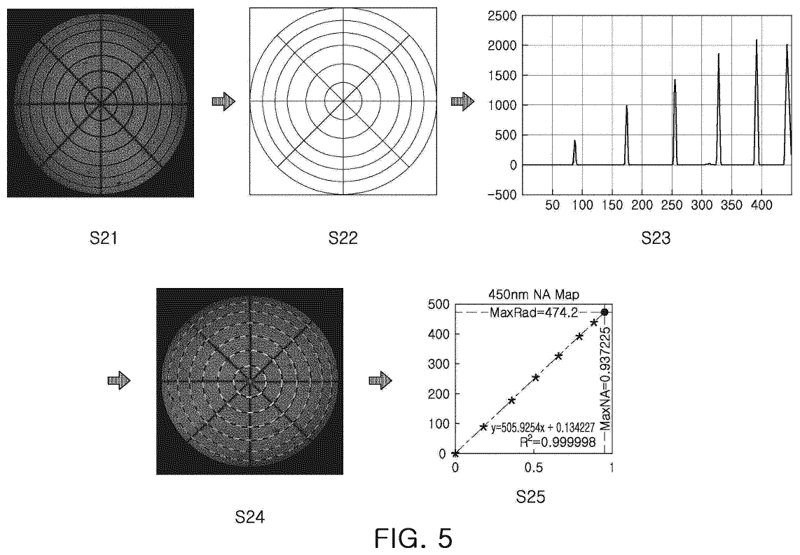

FIG. 5 is a view illustrating an example method of processing an image on a back focal plane.

In operation S21, a controller 160 may capture light transmitted through relay lenses 145 and 156 using a first image sensor 151 to obtain an original image. For example, the original image may be a gray scale image.

In the example of FIG. 5, a pupil image may be displayed in a relatively brighter color than an external portion. Furthermore, when a plurality of latitude lines 211 and a plurality of longitude lines 212 have lower reflectance than that of a spherical portion 210, a portion to which the plurality of latitude lines and the plurality of longitude lines are transferred in a pupil image may be displayed in a relatively dark color.

In operation S22, an optical measurement system 100 may generate a binary image by processing an original image. For example, the controller 160 may generate a binary image having only black and white depending on the brightness of a gray scale image obtained from a back focal plane image sensor 153. A plurality of concentric patterns generated by transferring a plurality of latitude lines in the binary image, radial patterns generated by transferring a plurality of longitude lines, and a boundary line of the pupil image may be emphasized.

In operation S23, the optical measurement system 100 may perform circular fitting to detect a circular pattern in the binary image, thus approximating the plurality of concentric patterns in a circular shape. For example, the circular fitting may be performed using a circle Hough transform algorithm by the controller 160. Meanwhile, the circular fitting may be performed by assuming that a center of the radial patterns of the binary image is the center of multiple circular patterns.

In operation S24, the optical measurement system 100 may calculate the radii of the circular patterns from an image on which the circular fitting is completed.

In operation S25, the optical measurement system 100 may calculate the numerical aperture of the objective lens 120 based on the radius of the plurality of concentric patterns and the radius of the pupil image.

In an example implementation, since the optical measurement system 100 may measure the numerical aperture of the objective lens 120 using an internal light source 130 in a state in which the objective lens 120 is mounted, the numerical aperture of the objective lens 120 may be measured in-situ.

Furthermore, since the optical measurement system 100 may measure the numerical aperture of the objective lens 120 based on the plurality of concentric patterns appearing in the back focal image 300, an error in measuring the numerical aperture may be corrected as compared to calculating the numerical aperture using a single reference value, thereby improving accuracy thereof.

Furthermore, the optical measurement system 100 may measure the numerical aperture of the objective lens 120 in all directions using the back focal image 300 having optical information from all directions. Due to a processing error of the objective lens 120, the numerical aperture of the objective lens 120 for each orientation may vary. According to an example implementation, the optical measurement system 100 may perform elliptical fitting instead of performing circular fitting using a binary image, in order to measure the numerical aperture in all directions. The optical measurement system 100 may measure the numerical aperture in all directions using the back focal image 300 obtained by capturing a single image, which will greatly improves the time required to measure the numerical aperture.

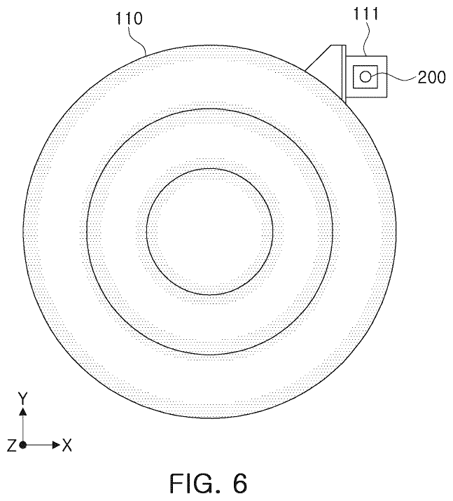

On the other hand, in order to obtain accurate aperture measurement results, the center of the spherical portion of the hemispherical mirror 200 needs to be accurately aligned with the focus of the objective lens 120. Hereinafter, a method of aligning the hemispherical mirror 200 in an example implementation will be described in detail with reference to FIGS. 6 to 10.

FIG. 6 is a view illustrating an example alignment system of a hemispherical mirror in an optical measurement system.

An optical measurement system 100 may be a system for measuring a semiconductor substrate, and may include a substrate chuck 110 for loading the semiconductor substrate. The substrate chuck 110 may be disposed on a stage of the optical measurement system 100.

In an example implementation, a hemispherical mirror 200 may be mounted on an alignment system 111 for tip-tilt control, and the alignment system 111 may be disposed on the stage. For example, the alignment system 111 may be attached to a side surface of the substrate chuck 110. According to an embodiment, the substrate chuck 110 and the alignment system 111 may be integrally formed.

For the alignment of the hemispherical mirror 200, the hemispherical mirror 200 may move in an X-direction, a Y-direction, and a Z-direction, and the tip-tilt control may be further performed. For example, the stage may move in the X-direction, the Y-direction, and the Z-direction, and the hemispherical mirror 200 may move in conjunction with the stage. Furthermore, the tip-tilt control of the hemispherical mirror 200 may be performed by the alignment system 111.

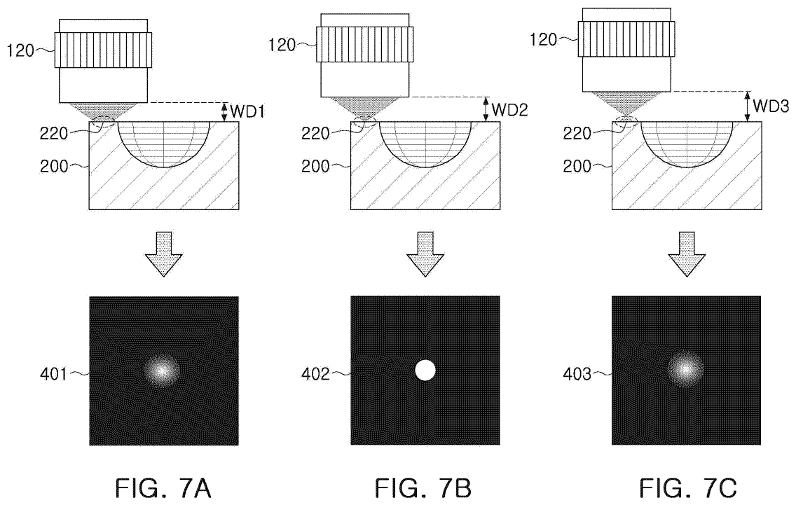

FIGS. 7A to 7C are views illustrating an example method of aligning a vertical position of a hemispherical mirror.

Referring to FIGS. 7A to 7C, the optical measurement system 100 may set a position on the X-Y plane of the hemispherical mirror 200 so that incident light from the objective lens 120 is irradiated to the planar portion 220 of the hemispherical mirror 200. Furthermore, the optical measurement system 100 may obtain a plurality of focus images 401, 402 and 403 by changing an operating distance of the objective lens 120 to first to third operating distances WD1 to WD3. The operating distance may be defined as a distance between the objective lens 120 and the hemispherical mirror 200. For example, the optical measurement system 100 may obtain the plurality of focus images 401, 402 and 403 using the second image sensor 152 of an optical unit 140 described with reference to FIG. 1.

Referring to FIG. 7A, in a state in which the objective lens 120 is disposed in a first operating distance WD1, the optical measurement system 100 may obtain a first focus image 401. The first operating distance WD1 may be shorter than a focal length of the objective lens 120, and a first original image 401 may be an image captured under an under-focused condition. Light reflected from the planar portion 220 may appear blurry on the first focus image 401.

Referring to FIG. 7B, in a state in which the objective lens 120 is disposed in a second operating distance WD2, the optical measurement system 100 may obtain a second focus image 402. The second operating distance WD2 may be matched with the focal length of the objective lens 120, and the light reflected from the planar portion 220 may appear clear on the second focus image 402.

Referring to FIG. 7C, in which the objective lens 120 is disposed in a third operating distance WD3, the optical measurement system 100 may obtain a third focus image 403. The third operating distance WD3 may be longer than the focal length of the objective lens 120, and the third focus image 403 may be an image captured under an overfocus condition. The light reflected from the planar portion 220 may appear blurry on the third focus image 403.

In an example implementation, the optical measurement system 100 may capture a plurality of focus images 401, 402 and 403 while changing a Z-axis position of the hemispherical mirror 200, and determine a Z-axis position displaying a clear original image as the Z-axis position of the hemispherical mirror 200.

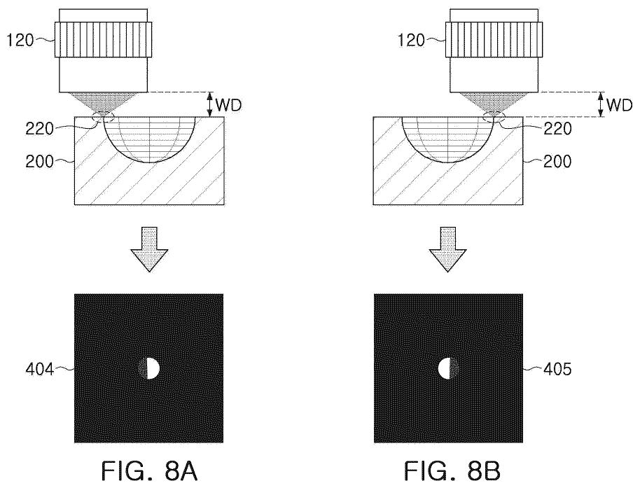

FIGS. 8A and 8B are views illustrating an example method of aligning horizontal positions of a hemispherical mirror.

Referring to FIGS. 8A and 8B, the optical measurement system 100 may obtain a plurality of original images 404 and 405 while changing an X-axis position and a Y-axis position of the hemispherical mirror 200 in a state in which the Z-axis position of the hemispherical mirror 200 is set.

When a focus of the objective lens 120 is disposed on a boundary between the spherical portion 210 and the planar portion 220, a relatively bright portion and a relatively dark portion may be displayed on the focus images 404 and 405. Since light incident on the planar portion 220 at the focus of the objective lens 120 may be unchangeably reflected and may be incident on the objective lens 120, the planar portion 220 may be displayed as a relatively bright portion on the focus images 404 and 405. On the other hand, since most of the light incident on the spherical portion 210 is reflected in a direction outside the focus of the objective lens 120, the spherical portion 210 may be displayed as a relatively dark portion on the focus images 404 and 405. On the other hand, since the light passing through the objective lens 120 forms an inverted image, the bright portion corresponding to the planar portion 220 and the dark portion corresponding to the spherical portion 210 in the focus images 404 and 405 may be displayed in left-right reversal.

The controller 160 may determine boundary positions of the hemispherical mirror 200 such that the focus of the objective lens 120 is disposed in the boundary line, and align a horizontal position of the hemispherical mirror 200 by determining a center position of the hemispherical mirror 200 such that the focus of the objective lens 120 is disposed in a center of the spherical portion 210, based on the boundary positions.

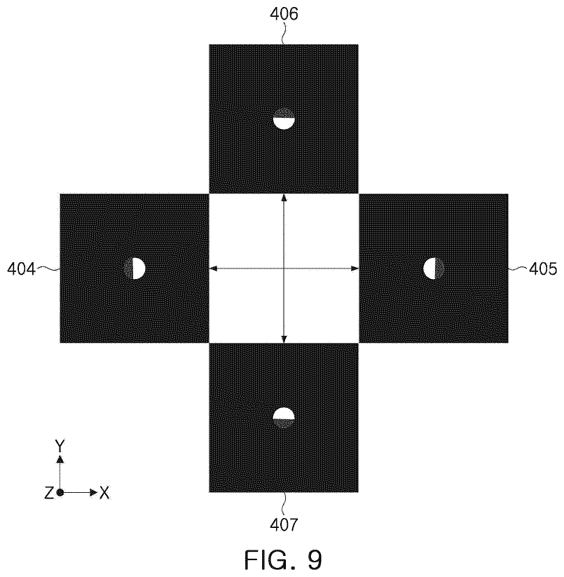

FIG. 9 is a view illustrating an example method of aligning horizontal positions of a hemispherical mirror.

FIG. 9 illustrates a plurality of focus images 404 to 407 captured at boundary positions of a hemispherical mirror 200, among a plurality of focus images captured while adjusting a horizontal position of the hemispherical mirror 200.

Images of which the boundary line is parallel to the Y-axis, such as focus images 404 and 405, may be images captured with both ends of the spherical portion 210 in the X-axis direction as a focus. Furthermore, images of which the boundary line is parallel to the X-axis, such as focus images 406 and 407, may be images captured with both ends of the spherical portion 210 in the Y-axis direction as a focus. On the other hand, the bright portion corresponding to the planar portion 220 and the dark portion corresponding to the spherical portion 210 may be displayed in left-right and up-and-down reversals in the focus images 404 to 407.

In an example implementation, a center of the boundary positions of the hemispherical mirror 200 corresponding to the focus images 404 to 407 may be determined as a center position of the hemispherical mirror 200.

On the other hand, when the hemispherical mirror 200 is inclined, a Z-axis position of the hemispherical mirror 200 may be aligned based on the planar portion 220, and even when an X-axis position and a Y-axis position of the hemispherical mirror 200 are aligned, the focus of the objective lens 120 and the center of the spherical portion of the hemispherical mirror 200 may not be properly aligned. Furthermore, a shape of a plurality of concentric patterns may be distorted in a back focal image captured to measure the numerical aperture of the objective lens 120, and it may be difficult to accurately measure the numerical aperture.

In an example implementation, a controller 160 may detect an inclination of the hemispherical mirror 200 based on the sharpness of a plurality of original images 404 to 407. For example, when the hemispherical mirror 200 is inclined in the X-axis direction, at least one of a fourth focus image 404 and a fifth focus image 405 illustrated in FIG. 9 may have an image captured under the overfocus condition or the under-focused condition. When the inclination of the hemispherical mirror 200 is detected, the controller 160 may perform tip-tilt control of the hemispherical mirror 200 by controlling an alignment system 111 to offset the inclination.

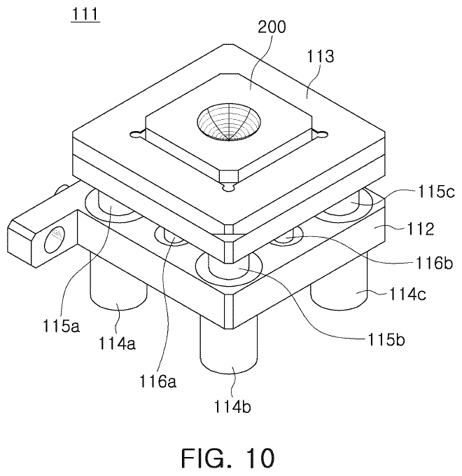

FIG. 10 is a view illustrating a structure of an example alignment system.

Referring to FIG. 10, an alignment system 111 in which a hemispherical mirror 200 is mounted is illustrated. The alignment system 111 may include a support 112, a fixing portion 113, a plurality of nuts 114a, 114b and 114c, a plurality of adjustment bolts 115a, 115b and 115c, and a plurality of springs 116a and 116b.

The support 112 may be mounted on a substrate chuck 110 described with reference to FIG. 6 to support the fixing portion 113. The fixing portion 113 may fix the hemispherical mirror 200. For example, the hemispherical mirror 200 may be inserted into the fixing portion 113 in a state in which the planar portion 220 and the spherical portion 210 are exposed.

The plurality of nuts 114a, 114b and 114c may penetrate through the support 112 from at least three vertical edges of the support 112. Furthermore, the plurality of adjustment bolts 115a, 115b and 115c may be fastened to the plurality of nuts 114a, 114b and 114c to penetrate through the support 112, and may support the fixing portion 113 above the support 112. A plurality of springs 116a and 116b may be connected to the support 112 and the fixing portion 113 to pull the fixing portion 113 downwardly.

In an example implementation, the controller 160 may perform the tip-tilt control of the hemispherical mirror 200 fixed to the fixing portion 113 by controlling a height at which each of the plurality of adjustment bolts 115a, 115b and 115c protrudes toward an upper surface of the support 112.

In an example implementation, an origin of the spherical portion of the hemispherical mirror 200 may be accurately aligned with the focus of the objective lens 120, and the optical measurement system 100 may precisely and accurately measure the numerical aperture of the objective lens 120.

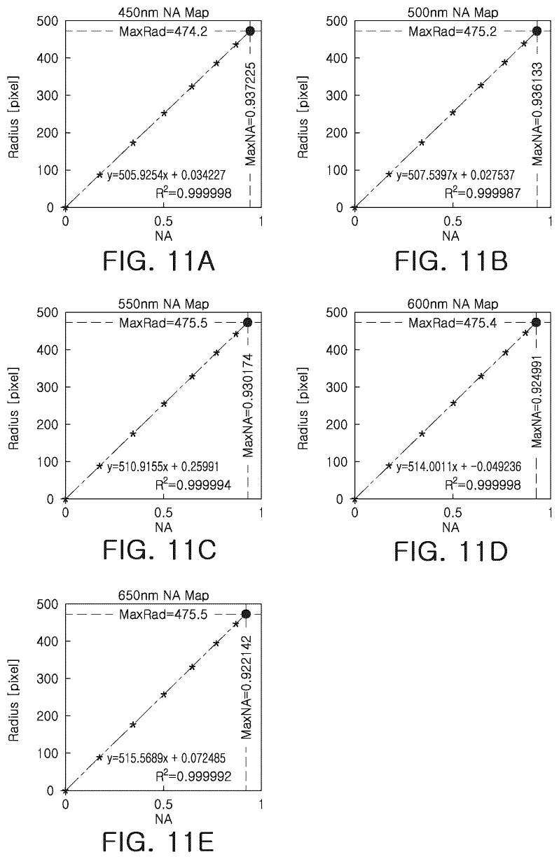

FIGS. 11A to 11E are graphs illustrating a numerical aperture for each wavelength of an objective lens measured.

FIGS. 11A to 11E may be graphs measuring the numerical aperture of the objective lens 120 according to a wavelength of the light source 130 by setting the wavelength of the light source 130 differently to 450 nm, 500 nm, 550 nm, 600 nm and 650 nm, respectively. When the wavelengths of the light sources 130 are different from each other, the numerical aperture of the objective lens 120 may vary due to chromatic aberration of the objective lens 120.

In the graphs of FIGS. 11A to 11E, a horizontal axis may represent a numerical aperture NA, and a vertical axis may represent a radius of a pupil image. In the graphs of FIGS. 11A to 11E, partial numerical apertures corresponding to a plurality of concentric patterns 311 displayed in the back focal image 300 may be represented, a relationship between the radius of the pupil image and the numerical aperture of the objective lens 120 may be approximated as a linear function, and the numerical aperture MaxNA of the objective lens calculated based on the linear function and a radius MaxRad of the pupil image may be represented.

Referring to FIGS. 11A to 11E, a determination coefficient R² of the linear function derived by a regression analysis may have a value close to 1. As the determination coefficient R² has a value closer to 1, the precision of the partial opening numbers measured based on a plurality of latitude lines 211 of the hemispherical mirror 200 and the plurality of concentric patterns 311 of the back focal image 300 may be high.

In an example implementation, the optical measurement system 100 may accurately measure the numerical aperture of the objective lens 120 in various wavelength bands.

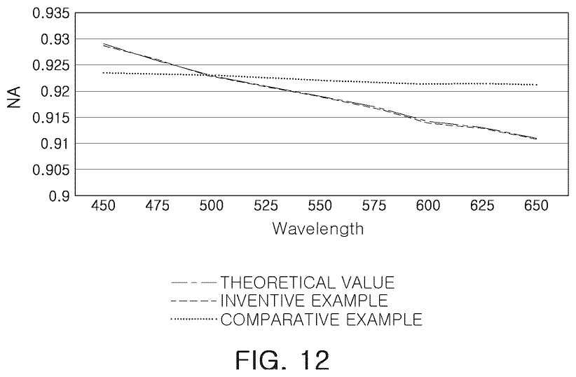

FIG. 12 is a graph illustrating the accuracy of the measurement of a numerical aperture of an objective lens according to an example implementation of the present disclosure.

The graph of FIG. 12 is a graph for comparing a theoretical value of a numerical aperture of the objective lens, a numerical aperture measured in an example implementation, and a numerical aperture measured according to a comparative example different from an example implementation of the present disclosure. A horizontal axis of the graph of FIG. 12 may represent a wavelength of a light source, and a vertical axis thereof may represent the numerical aperture NA.

The theoretical value may be a numerical aperture value of the objective lens determined from a result of measuring a SiO₂ film formed on a wafer surface by an ellipsometry measurement method, which may be an accurate value determined using a SiO₂ film whose exact thickness is known. A comparative example may refer to a method of measuring the numerical aperture of an objective lens using the diffraction grating method described above.

Referring to FIG. 12, a reference value in all measured wavelength ranges and the numerical aperture in an example implementation may be approximately matched with each other. On the other hand, the reference value and the numerical aperture according to comparative example may vary greatly depending on the wavelength of the light source.

Since the method for measuring the numerical aperture of the objective lens in an example implementation is based on a plurality of concentric patterns 311 displayed in a back focal image 300, the numerical aperture may be measured using various reference values as compared to comparative example in which the numerical aperture is measured using only the +1st order diffracted light pattern. Accordingly, the accuracy of measuring the numerical aperture may be improved.

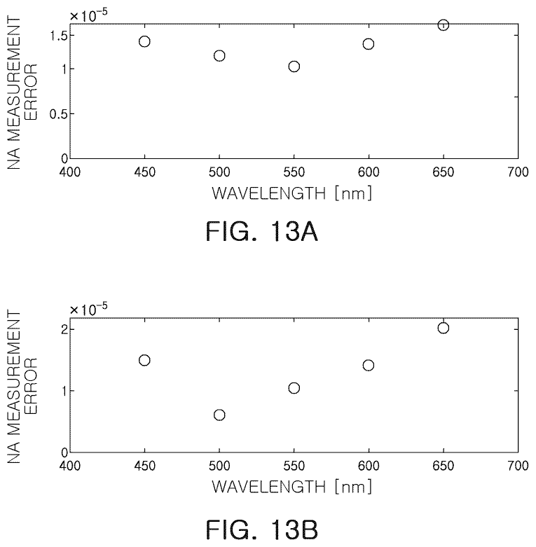

FIGS. 13A and 13B are views illustrating the repeatability of an example measurement method of a numerical aperture of an objective lens.

FIG. 13A is a graph illustrating the repeatability of measuring the numerical aperture of the objective lens of the hemispherical mirror 200. For example, FIG. 13A illustrates a result of calculating a measurement error due to facility vibrations, shot noise of a camera, image processing, and the like, by moving an X-axis position and a Y-axis position of the hemispherical mirror 200 to positions that are not aligned with the objective lens 120, and repeating an operation of capturing an image of the back focal plane once 10 times after rearranging the X-axis position and the Y-axis position of the hemispherical mirror 200 to the objective lens 120.

Referring to FIG. 13A, an aperture measurement error in all measured wavelength ranges may be equal to or less than 10⁻⁵.

FIG. 13B is a graph illustrating the precision of measuring the numerical aperture according to an alignment error of the hemispherical mirror 200. For example, FIG. 13B is a result of obtaining seven numerical aperture measurement values according to the X-axis direction position by moving the hemispherical mirror 200 by 100 nm in the range of +300 nm in the X-axis direction and calculating measurement errors.

Referring to FIG. 13B, even when there is an alignment error in the hemispherical mirror 200, an aperture measurement error in all measured wavelength ranges may be 10⁻⁵ or less.

Referring to FIGS. 13A and 13B, even when the measurement error occurs, the precision of measuring the numerical aperture of the objective lens 120 may be improved.

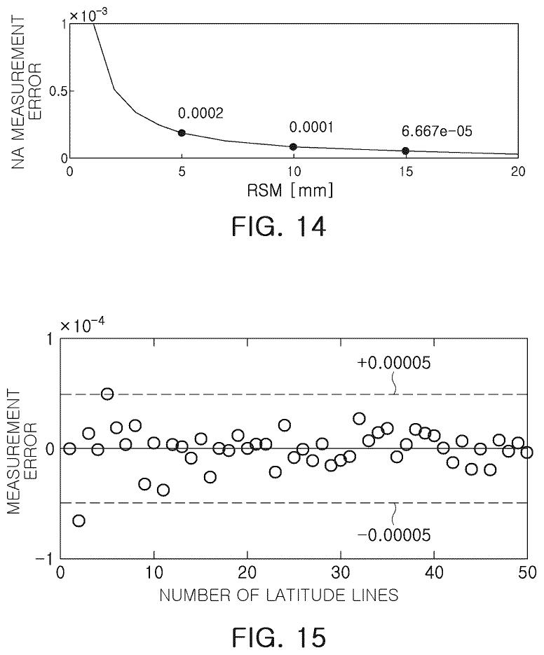

FIG. 14 is a graph illustrating the precision of an example method of measuring a numerical aperture of an objective lens according to a radius of a hemispherical mirror.

The hemispherical mirror 200 may have a processing error. For example, when processing the hemispherical mirror 200 using a diamond turning method, an error of ±1 μm may occur with a standard deviation of 3 sigma in the radius of the hemispherical mirror 200.

FIG. 14 may be a graph illustrating a simulation result of an aperture measurement error according to the radius of the hemispherical mirror 200 when there is an error of 1 μm in the radius of the hemispherical mirror 200. When the radius of the hemispherical mirror 200 is 5 mm, an error of the numerical aperture may be simulated as 0.0002. When the size of the error in the radius of the hemispherical mirror 200 is the same at 1 μm, as the radius increases, the error rate may decrease, thereby reducing the error of the numerical aperture.

Meanwhile, the radius of the hemispherical mirror 200 may be determined in consideration of the aperture measurement error and a size of a space occupied by the hemispherical mirror 200 in the optical measurement system 100. For example, when the hemispherical mirror 200 has a radius of 5 mm to 10 mm, the aperture measurement error may be sufficiently low and the hemispherical mirror 200 may occupy a smaller space than a stage of the optical measurement system 100, so that the hemispherical mirror 200 may be mounted all the times on the stage and may be used to measure the numerical aperture of the objective lens 120 in the mounting environment of the objective lens 120.

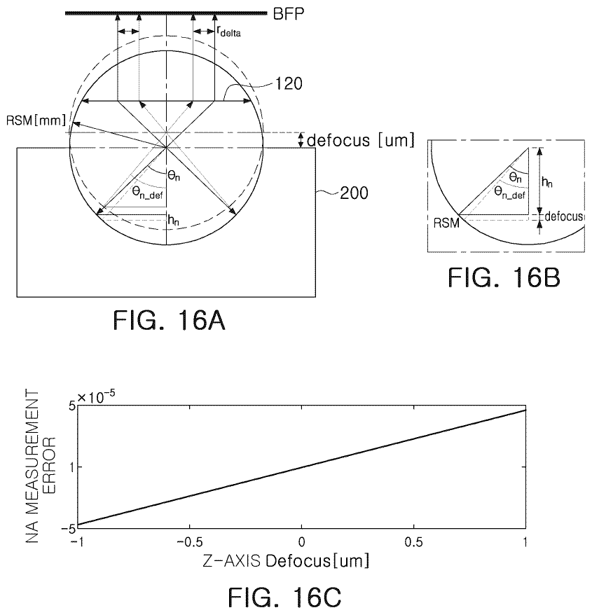

FIG. 15 is a graph illustrating precision of an example measurement method of a numerical aperture of an objective lens according to the number of latitude lines formed in a hemispherical mirror.

Due to a processing error of a hemispherical mirror 200, errors may also occur in a position of a plurality of latitude lines 211 formed in the hemispherical mirror 200 and a gap between the plurality of latitude lines 211. In an example implementation, as the number of latitude lines formed in the hemispherical mirror 200 increases, a plurality of reference values may be obtained from a back focal image, thereby reducing measurement errors in the numerical aperture.

FIG. 15 is a graph for simulating the measurement error of a numerical aperture according to the number of latitude lines when the latitude line has an error of +1 μm at a standard deviation of 3 sigma. When the number of latitude lines is small, the measurement error of the numerical aperture may be ±0.00005 or more, but as the number of latitude lines increases, the measurement error of the numerical aperture may be closed to zero.

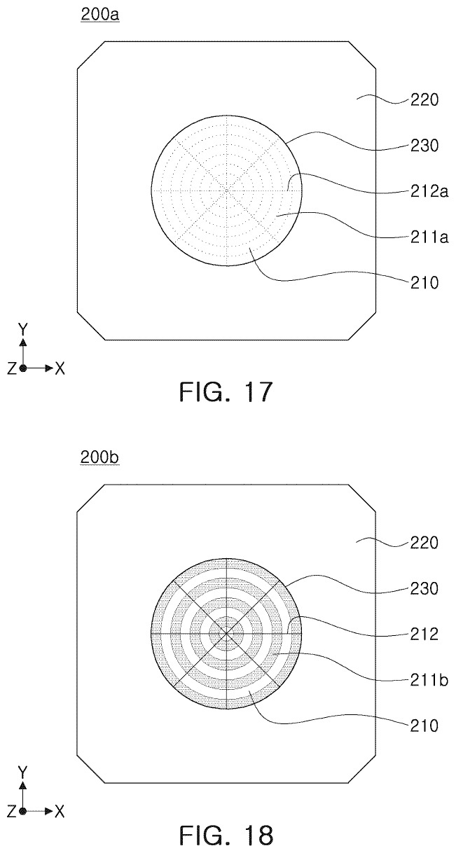

FIGS. 16A to 16C are views illustrating the precision of an example measurement method of a numerical aperture of an objective lens according to a processing error of a hemispherical mirror.

In an ideal case, since a spherical portion 210 is processed into a hemispherical recessed shape from a planar portion 220, a center of the spherical portion 210 may be included in a plane extending the planar portion 220. That is, a height of the center may be matched with a height of the planar portion 220.

Referring to FIGS. 16A and 16B, due to processing errors of the spherical portion 210 and the planar portion 220, the height of the origin of the spherical portion 210 and the height of the planar portion 220 may be different from each other. As described with reference to FIG. 7, when an objective lens 120 is focused based on the planar portion 220, defocusing may occur in which the focus of the objective lens 120 and the center of the spherical portion 210 are not matched with each other due to the processing error.

When the defocusing occurs, an incident angle of light incident from the objective lens to the spherical portion 210 may be different from a reflection angle of light reflected from the spherical portion 210. When calculating the numerical aperture of the objective lens 120 using a back focal image generated by allowing light reflected from the spherical portion 210 to be incident on the back focal plane (BFP), errors may occur in the calculated numerical aperture.

The partial numerical aperture NAₙ in the nth concentric circle of the back focal image may be calculated as Equation 3 below.

$${NA}_{n\_def} = sin ( arc cos ( \frac{cos ( {θ}_{n} ) \times RSM + defocus}{R S M} ) ) \qquad < Equation 3 >$$

In Equation 3, defocus may represent a height difference between the center of the spherical portion 210 and the planar portion 220, RSM may represent a radius of the spherical portion 210, and On may represent a latitude of the nth latitude line.

FIG. 16C illustrates results of simulating a numerical aperture measurement error according to a degree of defocusing based on Equation 3 above when the radius of the spherical portion 210 is 10 mm. A dimension of a hemispherical mirror 200 may have an error of +1 μm at a standard deviation of 3 sigma, and a hemispherical mirror 200 defocusing in the range of +1 μm may be used in the optical measurement system 100. Referring to FIG. 16C, when the defocusing of +1 μm occurs, the numerical aperture measurement error is only 0.00005. That is, even if there is a processing error in the hemispherical mirror 200, the numerical aperture may be accurately measured.

Meanwhile, the spherical portion of the hemispherical mirror may be implemented in various structures.

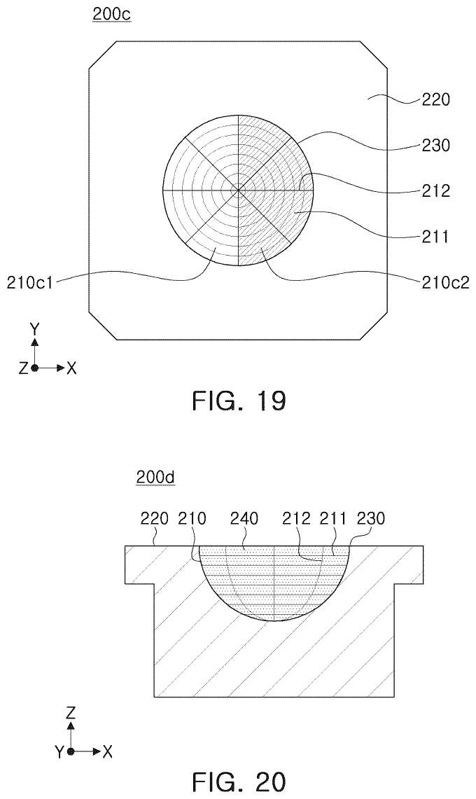

FIGS. 17 to 20 are views illustrating example structures of a hemispherical mirror according to implementations of the present disclosure.

Referring to FIG. 17, a hemispherical mirror 200a may have a spherical portion 210, a planar portion 220, and a boundary line 230 having the same structure as described with reference to FIGS. 2A to 2C. However, instead of a plurality of latitude lines 211 and a plurality of longitude lines 212, the hemispherical mirror 200a of FIG. 17 may include a plurality of first points 211a formed at predetermined latitude intervals and a plurality of second points 212a formed at predetermined longitude intervals. That is, the hemispherical mirror 200a may include the plurality of first points 211a as a latitude marker.

A back focal image formed by light reflected from the hemispherical mirror 200a and incident on the objective lens 120 may have a plurality of points formed by transferring the plurality of first points 211a and the plurality of second points 212a. The controller 160 may detect a plurality of concentric patterns as described with reference to FIG. 3 by performing image processing on the back focal image.

Referring to FIG. 18, a hemispherical mirror 200b may have a spherical portion 210, a plurality of longitude lines 212, a planar portion 220, and a boundary line 230 having the same structure as described with reference to FIGS. 2A to 2C. However, the hemispherical mirror 200b of FIG. 18 may include a plurality of marker regions 211b formed in a predetermined latitude range, instead of a plurality of latitude lines 211. That is, the hemispherical mirror 200b may include a plurality of marker regions 211b as a latitude marker. According to an example embodiment, a plurality of marker regions 211b may be formed by grinding a partial region of the spherical portion 210.

The back focal image formed by light reflected from the hemispherical mirror 200b and incident on the objective lens 120 may have a plurality of patterns formed by transferring the plurality of marker regions 211b. The controller 160 may detect a plurality of concentric patterns as described with reference to FIG. 3 by processing an image on the back focal image.

Referring to FIG. 19, a hemispherical mirror 200c may include a first spherical portion 210cl, a second spherical portion 210c2, a planar portion 220, and a boundary line 230. Furthermore, a plurality of latitude lines 211 and a plurality of longitude lines 212 may be formed in the first spherical portion 210cl and the second spherical portion 210c2.

The first spherical portion 210cl and the second spherical portion 210c2 may correspond to portions which are obtained by dividing the spherical portion 210 by a plane passing through an origin of the spherical portion 210 and perpendicular to the planar portion 220 as described with reference to FIG. 2. The first spherical portion 210cl and the second spherical portion 210c2 may be coated with materials having different levels of reflectance depending on wavelength. For example, in an ultraviolet band, a reflectance of the first spherical portion 210cl may be higher than that of the second spherical portion 210c2, and in an infrared band, a reflectance of the second spherical portion 210c2 may be higher than that of the first spherical portion 210c1.

An optical measurement system 100 may irradiate light to the hemispherical mirror 200c while adjusting a wavelength of a light source 130 to measure a numerical aperture according to a wavelength of the objective lens 120. When the light source 130 outputs light in the ultraviolet band, a semicircular portion corresponding to the first spherical portion 210cl may be relatively brightly displayed in a pupil image included in the back focal image, and when the light source 130 outputs light in the infrared band, a semicircular portion corresponding to the second spherical portion 210c2 may be relatively brightly displayed in the pupil image included in the back focal image.

As the semicircular portion of the back focal image becomes brighter, concentric circle patterns may further contrast with the semicircular portion, thereby easily detecting the concentric patterns. Since each of the back focal images captured based on the light sources 130 of various wavelength bands may include a bright semicircular region, the optical measurement system 100 may easily measure the numerical aperture of the objective lens 120 in various wavelength bands.

Referring to FIG. 20, a hemispherical mirror 200d may have a spherical portion 210, a plurality of latitude lines 211, a plurality of longitude lines 212, a planar portion 220, and a boundary line 230 having the same structure as described with reference to FIGS. 2A to 2C.

In an example implementation, the hemispherical mirror 200d may further include a liquid 240 filling a space surrounded by the spherical portion 210. The optical measuring system 100 may increase the numerical aperture of the objective lens 120, and liquid may be used as a medium between the objective lens 120 and the sample to increase the resolution of an image, in which case the objective lens 120 may be referred to as an immersion lens.

In an example implementation, the controller 160 may measure the numerical aperture of the immersion lens by obtaining a back focal image in a state in which the hemispherical mirror 200d is filled with the liquid 240 used as a medium in the spherical portion 210.

The optical measurement system 100 in an example implementation may allow light from an internal light source to be incident on a spherical portion of a hemispherical mirror having a plurality of latitude markers formed on the spherical portion to have a reflectance different from that of the spherical portion and an internal light source in a state in which the focus of the objective lens and a center of the spherical portion of the hemispherical mirror are matched, and may measure the numerical aperture of the objective lens using patterns of the plurality of latitude markers transcribed to the back focal image of the objective lens. Accordingly, the optical measurement system 100 may measure the numerical aperture of the objective lens in situ.

Furthermore, the optical measurement system 100 may accurately measure the numerical aperture of the objective lens based on the plurality of circular patterns detected which are based on the patterns of the plurality of latitude markers transferred to the back focal image. Furthermore, since the optical measurement system 100 may measure the numerical aperture of the objective lens in all directions with a single back focal image, a time for measuring the numerical aperture in all directions may be improved.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a combination can in some cases be excised from the combination, and the combination may be directed to a subcombination or variation of a subcombination.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

1. An optical measurement system comprising:
a hemispherical mirror including:
a planar portion,
a spherical portion having a hemispherical recessed shape in the planar portion, and
a plurality of latitude markers formed in the spherical portion and having different reflectance from the spherical portion;
an optical unit including:
an objective lens configured to allow light incident from a light source to be incident on the hemispherical mirror, and
at least one beam splitter configured to transmit light reflected from the hemispherical mirror and incident on the objective lens, to a first sensor; and
a controller configured to measure a numerical aperture of the objective lens using a back focal image of the objective lens from the first sensor in a state in which the hemispherical mirror is placed so that a focus of the objective lens and a center of the spherical portion of the hemispherical mirror are aligned with each other.

2. The optical measurement system of claim 1, wherein the controller is configured to:
detect a plurality of circular patterns formed by an image of each of the plurality of latitude markers in the back focal image, and
determine the numerical aperture of the objective lens based on a sine function value for each of the plurality of latitudes indicated by the plurality of latitude markers, a radius of each of the plurality of circular patterns, and a radius of a pupil image in the back focal image.

3. The optical measurement system of claim 2, wherein the controller is configured to:
determine the sine function value for each of the plurality of latitudes based on a radius of a latitude line of each of the plurality of latitudes indicated by the plurality of latitude markers and a radius of the spherical portion,
determine a partial numerical aperture of the objective lens according to the radius of each of the plurality of circular patterns based on the sine function value for each of the plurality of latitudes and the radius of each of the plurality of circular patterns, and
determine the numerical aperture of the objective lens according to the radius of the pupil image based on the partial numerical aperture of the objective lens according to the radius of each of the plurality of circular patterns.

4. The optical measurement system of claim 1, wherein the optical unit further comprises a condensing lens configured to condense light incident on the objective lens and transmit the light to a second sensor.

5. The optical measurement system of claim 4, wherein the controller is configured to align a vertical position, perpendicular to the planar portion, using a focus image of the objective lens from the second sensor, when the hemispherical mirror is positioned so that the focus of the objective lens is disposed on the planar portion.

6. The optical measurement system of claim 5, wherein the controller is configured to:
determine boundary positions of the hemispherical mirror, when the vertical position of the hemispherical mirror is aligned with the focus of the objective lens, such that the focus of the objective lens is disposed on a boundary line between the planar portion and the spherical portion using the focus image from the second sensor by varying horizontal positions along the planar portion,
determine the center of the spherical portion based on the boundary positions of the hemispherical mirror, and
align a horizontal position of the hemispherical mirror so that the focus of the objective lens is disposed at the center of the spherical portion.

7. The optical measurement system of claim 6, wherein the controller is configured to:
detect an inclination of the hemispherical mirror based on a sharpness of the focus images obtained from the boundary positions, and
control a tilt of the hemispherical mirror so as to offset the inclination of the hemispherical mirror.

8. The optical measurement system of claim 1, wherein the spherical portion comprises a first spherical portion and a second spherical portion formed of materials having different reflectances.

9. The optical measurement system of claim 8, wherein the first spherical portion and the second spherical portion correspond to portions obtained by dividing the spherical portion by a plane which is perpendicular to the planar portion and passing through the center of the spherical portion, the first spherical portion has a higher reflectance than the second spherical portion in an infrared wavelength band, and the second spherical portion has a higher reflectance than the first spherical portion in an ultraviolet wavelength band.

10. The optical measurement system of claim 1, wherein the hemispherical mirror further comprises a liquid filling a hemispherical space formed by the spherical portion.

11. The optical measurement system of claim 1, wherein the plurality of latitude markers include a plurality of latitude lines formed at predetermined latitude intervals.

12. The optical measurement system of claim 11, wherein the plurality of latitude lines are formed to have a reflectance different from that of the spherical portion by being engraved or embossed on the spherical portion.

13-14. (canceled)

15. The optical measurement system of claim 1, wherein the plurality of latitude markers includes a plurality of marker regions formed in each of a plurality of latitude ranges.

16. (canceled)

17. The optical measurement system of claim 1, wherein the hemispherical mirror further includes a plurality of longitude markers formed in the spherical portion to have a reflectance different from that of the spherical portion.

18. An optical measurement system comprising:
a hemispherical mirror including a planar portion, a spherical portion having a hemispherical recessed shape in the planar portion, and a plurality of latitude markers formed in the spherical portion having a reflectance different from that of the spherical portion;
a stage in which are disposed a substrate chuck for loading a semiconductor substrate and an alignment system equipped with the hemispherical mirror;
an optical unit including an objective lens configured to allow light incident from a light source to be incident on a target, and a beam splitter configured to transmit light reflected from the target and incident on the objective lens to a first sensor; and
a controller configured to set the hemispherical mirror as the target of the objective lens by adjusting a position of the stage, and configured to measure a numerical aperture of the objective lens using a back focal image of the objective lens from the first sensor.

19. The optical measurement system of claim 18, wherein the controller is configured to align the planar portion of the hemispherical mirror to be parallel to a back focal plane of the objective lens by performing tip-tilt control of the hemispherical mirror using the alignment system.

20. The optical measurement system of claim 18, wherein the alignment system comprises:
a fixing portion on which the hemispherical mirror is mounted;
a support mounted on the substrate chuck and configured to support the fixing portion;
a plurality of nuts penetrating through the support on at least three vertical edges of the support;
a plurality of adjustment bolts penetrating through the support by being fastened to the plurality of nuts and configured to support the fixing portion above the support, and
a plurality of springs configured to connect the support and the fixing portion.

21. The optical measurement system of claim 20, wherein the controller is configured to perform tip-tilt control of the hemispherical mirror mounted to the fixing portion by controlling a height at which each of the plurality of adjustment bolts of the alignment system protrudes to an upper surface of the support.

22. The optical measurement system of claim 18, wherein the controller is configured to control a position of the hemispherical mirror by controlling a movement of the stage in directions parallel to an upper surface of the stage, and in a direction perpendicular to the upper surface of the stage.

23-25. (canceled)

26. An optical measurement system comprising:
a hemispherical mirror including a plurality of latitude markers formed in a spherical portion to have different reflectance from the spherical portion;
a light source;
an objective lens; and
a controller configured to:
match a center of the spherical portion with a focus of the objective lens;
allow light output from the light source to be incident on the spherical portion through the objective lens;
detect circular patterns formed by the plurality of latitude markers in a back focal image of the objective lens;
calculate a partial numerical aperture of the objective lens according to a radius of each of the circular patterns based on the radius of each of the circular patterns and a latitude indicated by the plurality of latitude markers; and
determine the numerical aperture of the objective lens according to a radius of a pupil image in the back focal image, based on the partial numerical aperture according to the radius of each of the circular patterns.
